(19) United States
(12) Patent Application Publication
(10) Pub. No.: US 2009/0144442 A1
(43) Pub. Date: Jun. 4, 2009

(54) ACCESS NETWORK SYSTEM WITH SEPARATED CONTROL AND BEARER AND METHOD THEREOF FOR ACHIEVING COMMUNICATIONS

(75) Inventors: Ruobin ZHENG, Shenzhen (CN); Hongyu LI, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/364,311

(22) Filed: Feb. 2, 2009

Related U.S. Application Data
(63) Continuation of application No. PCT/CN2007/070362, filed on Jul. 26, 2007.

(30) Foreign Application Priority Data
Aug. 11, 2006 (CN) 200610112114.0

(51) Int. Cl. G06F 15/16

(52) U.S. Cl. 709/236; 709/230

(57) ABSTRACT

An access network system with separated control and bearer includes an access network control plane and an access network data plane for achieving separation of control and bearer. The access network control plane receives the control information separated from the access network data plane, exchanges the control information with a core network, and control data transfer of the access network data plane. The access network data plane separates control information from data when dealing with flow from a user network, transfers the control information to the access network control plane, and forwards the data from the user network/core network according to the control information of the access network control plane. A method for implementing communications by an access network system with separated control and bearer is provided. Because the access network of the present invention implements separation of control and bearer, the network control method does not need to alter when the bearing technique changes, thereby improving network extensibility and reducing the network maintenance cost.

### CROSS REFERENCE TO RELATED APPLICATIONS

This application is a continuation of International Patent Application No. PCT/CN2007/070362, filed Jul. 26, 2007, which claims priority to Chinese Patent Application No. 200610112114.0, filed Aug. 11, 2006, both of which are hereby incorporated by reference in their entirety.

### FIELD OF THE INVENTION

The present invention relates to access network technologies, and more particularly, to an access network system with separated control and bearer as well as methods thereof for achieving communications.

### BACKGROUND

In the existing communication network architecture, the control and the bearer in an access network are not separated from each other. From the perspective of the whole network control, because different bearing techniques correspond to different architectures and different network control methods, the convergence of access networks is impossible. When there are lots of service providers in the network who manage their own services separately, cross-region movements and handoffs of a user are affected. Moreover, because access networks using different bearing techniques need to be managed separately, there is an increasing difficulty in implementing movements and handoffs of a user among different access technologies. From the perspective of devices in the network, if the control and the bearer reside in the same bearing device, the bearing device includes lots of control functions, increasing the cost of the device tremendously. Furthermore, the performance of the control device is affected due to hardware limitations, and the control function is further affected when the bearing device is upgraded or expended. Moreover, because the control function resides in the bearing device, the whole bearing device needs to be upgraded when a new control function is required. Accordingly, the capital expense (CAPEX) and the operational expense (OPEX) are increased.

Consequently, the network control method of an existing access network with non-separated control and bearer needs to vary with the bearing technique. As a result, the network extensibility is decreased and the network maintenance cost is increased.

### SUMMARY

In view of the problems described above, the present invention provides an access network system with control and bearer that are separated from each other. Such system may improve the network extensibility and reduce the network maintenance cost.

The present invention further provides a method for implementing communications by an access network system with separated control and bearer, thus enabling users to communicate over the access network of the present invention.

For achieving the above objectives, the technical schemes of the present invention are described as follows.

An access network system with separated control and bearer includes an access network control plane and an access network data plane that are separated from each other. The access network control plane receives control information, separated from the access network data plane, exchanges the control information with a core network, and controls data transfers of the access network data plane. The access network data plane separates control information from data for traffic from a user network, transfers the control information to the access network control plane, and forwards the data from the user network/core network under control of the access network control plane.

A method for achieving communications utilizing an access network system with separated control and bearer includes: separating, by an access network data plane, control information from data in a user uplink traffic, transferring the separated control information to an access network control plane for processing, and exchanging the control information with a core network; forwarding, by the access network data plane, the separated data and downlink data from the core network under control of the access network control plane.

As shown in the technical schemes above, because the access network of the present invention implements a separation of the control and the bearer, it is not required to update the network control method when the bearing technique is changed, therefore the network extensibility is improved and the network maintenance cost is reduced. The control portion is separated from the existing bearing device to form a stand-alone controller, thereby reducing the cost of the bearing device significantly. Meanwhile, the controller is not constrained by the hardware of the bearing device, thereby providing better control performance. The separated controller may provide more higher-quality control functions due to additional control function modules and new services may also be supported conveniently by adding new modules into the controller. Accordingly, the network extensibility is improved.

Moreover, in the access network with separated control and bearer, the controller may be upgraded to improve control performances while the bearing network device is not affected. The upgrades and modifications of the bearing network device do not affect user's controls, and it is not required to alter the user's administration control information when the bearing device is modified, thus reducing the network maintenance cost dramatically.

In addition, based on the separation of the access network control plane and the access network data plane of the present invention, control planes of different bearing technologies may be combined together to provide a uniform control plane for different bearing techniques. The uniform management for services from a plurality of service providers may be supported with the uniform control plane, enabling the access network system of the present invention to be applicable for multiple SPs, and solving the problems such as cross-region handoff and roaming of users. The uniform control plane achieves the uniform management for different access technologies, thus solving the problems such as handoff between different access technologies and roaming of users.

### BRIEF DESCRIPTION OF THE DRAWINGS

FIG. 1 is a schematic diagram of an access network with control and bearer separated from each other according to the present invention.

FIG. 2a is a network model of an access network according to one embodiment of the present invention.

FIG. 2b is network model of an access network according to another embodiment of the present invention.

FIG. 3a is a first schematic diagram of an access network system of the present invention.

FIG. 3b is a second schematic diagram of an access network system of the present invention.

FIG. 3c is a third schematic diagram of an access network system of the present invention.

FIG. 4a is a first embodiment of an access network for implementing user authentication of the present invention.

FIG. 4b is a second embodiment of an access network for implementing user authentication of the present invention.

FIG. 4c is a third embodiment of an access network for implementing user authentication of the present invention.

FIG. 5 is a flowchart of user authentication based on an access network system of the present invention.

FIG. 6a is a flowchart of a first embodiment for a DHCP process.

FIG. 6b is a flowchart of a second embodiment for a DHCP process.

FIG. 7a is a first application of an access network of the present invention in FTTx.

FIG. 7b is a second application of an access network of the present invention in FTTx.

FIG. 7c is a third application of an access network of the present invention in FTTx.

FIG. 8a is a first application of an access network of the present invention in DSL.

FIG. 8b is a second application of an access network of the present invention in DSL.

FIG. 8c is a third application of an access network of the present invention in DSL.

FIG. 9a is a first application of an access network of the present invention in a wireless network.

FIG. 9b is a second application of an access network of the present invention in a wireless network.

FIG. 9c is a third application of an access network of the present invention in a wireless network.

### DETAILED DESCRIPTION

A scheme of the present invention is described as follows.

An access network including an access network control plane and an access network data plane which are separated from each other achieves separation of control and bearer. The access network control plane receives control information separated from the access network data plane, exchanges the control information with a core network, and controls data transfer of the access network data plane. The access network data plane separates control information from the data when dealing with the traffic from a user network, forwards the control information to the access network control plane, and forwards the data from the user network/core network under control of the access network control plane.

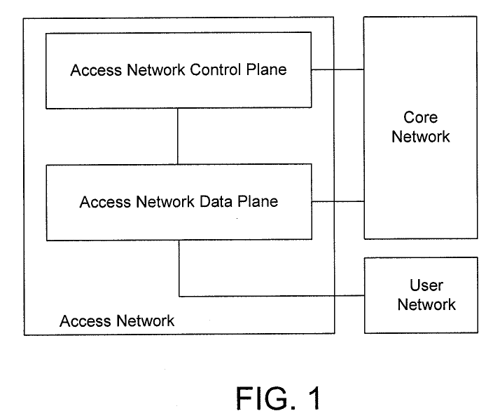

FIG. 1 is a schematic diagram of an access network with control and bearer separated from each other according to the present invention. As illustrated in FIG. 1, the access network includes an access network control plane (Access Network-CP) and an access network data plane (Access Network-DP) which are separated from each other, enabling the convergence of control planes with different bearing techniques, so as to provide a unified control plane for different bearing techniques. The access network control plane is integrated with control function of the access network, for receiving control information separated from the access network data plane, exchanging the control information with a core network, and controlling data transfer of the access network data plane. The control herein includes control of authentication, resources, admission and strategy, as well as control of data transfer of the access network data plane. These control functions may be provided in a controller. The access network data plane separates control information from data when dealing with the traffic from the user network, forwards the separated control information to the access network control plane, and forwards the data from the user network/core network to the core network/user network under control of the access network control plane. The separation belongs to prior art, such as separating the control information and data by a protocol number or a port number of a flow classification detection message, and is not repeated here for clarity.

The access network control plane may be an independent wired access network control plane or wireless access network control plane, or may be a converged access network control plane converging (including) a wired access network control plane and a wireless access network control plane, i.e., the wired access network control plane and the wireless access network control plane employ the same access network control plane. Then, the controller includes the function of a wired controller and a wireless controller, and the controller including the function of a wired controller and a wireless controller is referred to as a Fixed and Mobile Convergence (FMC) controller herein.

The access network data plane may be an independent wired access network data plane or wireless access network data plane, or may be a converged access network data plane converging (including) a wired access network data plane and a wireless access network data plane, i.e., the wired access network data plane and the wireless access network data plane employ the same access network data plane.

The access network control plane may be owned by a connectivity provider (ConP) or a network access provider (NAP), and the access network data plane may be owned by a network access provider; the wired/wireless core network may be owned by a wired service provider (SP)/wireless SP, and the wired/wireless core network may be converged to be owned by the same SP.

For further clarifying the purposes, technical schemes and advantages of the present invention, the present invention is further described in detail below with reference to the accompanying drawings and preferred embodiments.

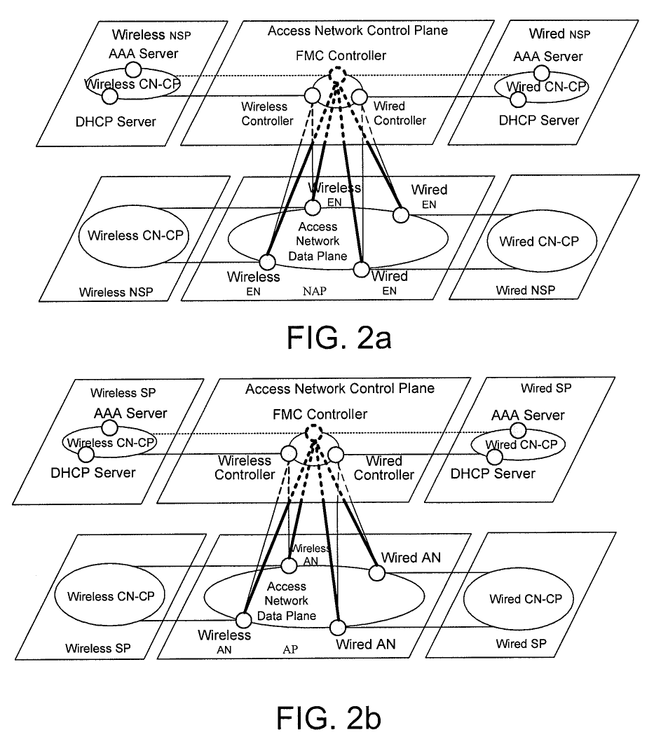

FIG. 2a is a network model of an access network with wired and wireless function employing a converged access network control plane and a converged access network data plane. In FIG. 2a, an access network control plane (Access Network-CP) includes a wired access network control plane and a wireless access network control plane, and an access network data plane (Access Network-DP) includes a wired access network data plane and a wireless access network data plane. FIG. 2a does not illustrate the wired/wireless access network control plane, or the wired/wireless access network data plane.

The wired access network control plane and the wired access network data plane form a wired access network, wherein the function of an edge node (EN), such as a broadband network gateway/broadband remote access server (BNG/BRAS), of the original wired access network are decomposed into two network elements, i.e., a wired controller and a wired EN. The wired controller has the control plane function of the EN of the original wired access network, including at least an authenticator and an Authentication/Authorization/Accounting Client (AAA Client) for implementing authentication function, handle of Dynamic Host Configuration Protocol (DHCP) relay/proxy, resources and admission control, and strategy control function, and may further including function such as: auto-configuration function of an auto-configuration server, residential gateway/routing gateway (RG) management, terminal and/or user device management in a user network, user private or temporary IP address assignment, an AAA agent or client, a Media Gateway Controller (MGC), as well as control function for handoff between wired access and wireless access, etc. The wired EN has the data plane function of the EN of the original wired access network. One-to-multiple or multiple-to-multiple connections may be employed between the wired controller and the wired EN.

The control function of the wired access network control plane is provided within the wired controller. For example, the AAA function separated from the BNG/BRAS is provided within the wired controller. The wired controller is connected to a control plane reference node of a core network (CN), and the wired EN of the wired access network data plane is connected to a data plane reference node of the CN.

The wireless access network control plane and the wireless access network data plane form a wireless access network, wherein the function of an EN, such as an Application Service Network Gateway (ASN GW), of the original wireless access network are decomposed into two network elements, i.e., a wireless controller and a wireless EN. The wireless controller has the control plane function of the EN of the original wireless access network, including at least an authenticator, an AAA client, DHCP relay/proxy, radio resource management resources and admission control, and strategy control function, and may further including functions such as handoff control, paging control, auto-configuration of an auto-configuration server, RG management, management function of terminals and/or user devices within a user network, user private or temporary address assignment, AAA agent, and MGC. In addition, the wireless controller may further include function of handoff control between wired access and wireless access, for achieving control of handoff between wired access and wireless access. The wireless EN has the data plane function of the EN of the original wireless access network. One-to-multiple or multiple-to-multiple connections may be employed between the wireless controller and the wireless EN.

The control function of the wireless access network control plane is provided within the wireless controller. For example, the AAA function separated from the ASN GW is provided within the wireless controller. The wireless controller is connected to the control plane reference node of the CN, and the wired EN of the wireless access network data plane is connected to the data plane reference node of the CN.

In FIG. 2a, the core network includes a wired core network and a wireless core network. The wired/wireless core network each has separated control and bearer, so as to introduce a wired/wireless core network control plane (CN-CP) and a wired/wireless core network data plane (CN-DP). The wired/wireless controller of the wired/wireless access network control plane is connected to a reference point of the wired/wireless core network control plane respectively, and the wired/wireless EN of the wired/wireless access network data plane is connected to the reference point of the wired/wireless core network data plane respectively. The wired core network may be owned by a wired service provider (SP), the wireless core network may be owned by a wireless SP, and the wired core network and the wireless core network may be converged to be owned by the same SP. In addition, the core network that converges a wired core network and a wireless core network is referred to as a converged core network herein. The architecture of the core network is not in the scope of the present invention, and is not described in detail.

As illustrated in FIG. 2a, the wired access network control plane and the wireless access network control plane employ the same access network control plane, the wired controller and the wireless controller may employ separated wired controller and wireless controller, or may employ an FMC controller (as illustrated by the dashed line and bold dashed line in FIG. 2a). The wired access network data plane and the wireless access network data plane employ the same access network data plane, the wired EN/wireless EN may employ a same access network data plane, and the wired AN/wireless AN may employ the same access network data plane (not shown in FIG. 2a). One-to-multiple or multiple-to-multiple connections may be employed between the FMC controller and the wired EN/wireless EN. The access network control plane may be owned by a connectivity provider, and the access network data plane may be owned by a network access provider.

FIG. 2b is another network model of an access network with wired and wireless function employing a converged access network control plane and a converged access network data plane. In FIG. 2b, the access network control plane includes a wired access network control plane and a wireless access network control plane, and the access network data plane includes a wired access network data plane and a wireless access network data plane. FIG. 2b does not illustrate the wired/wireless access network control plane, or the wired/wireless access network data plane. The distinctions of FIG. 2b from FIG. 2a are that the wired/wireless access network (AN) in the access network data plane is integrated with the function of the AN and EN of the original access network, the wired/wireless AN of the wired/wireless access network data plane is connected to a reference node of the data plane of the CN.

As illustrated in FIG. 2b, the wired AN/wireless AN/wired EN/wireless EN employs a converged access network data plane, one-to-multiple or multiple-to-multiple connections may be employed between the FMC controller and the wired AN/wireless AN/wired EN/wireless EN.

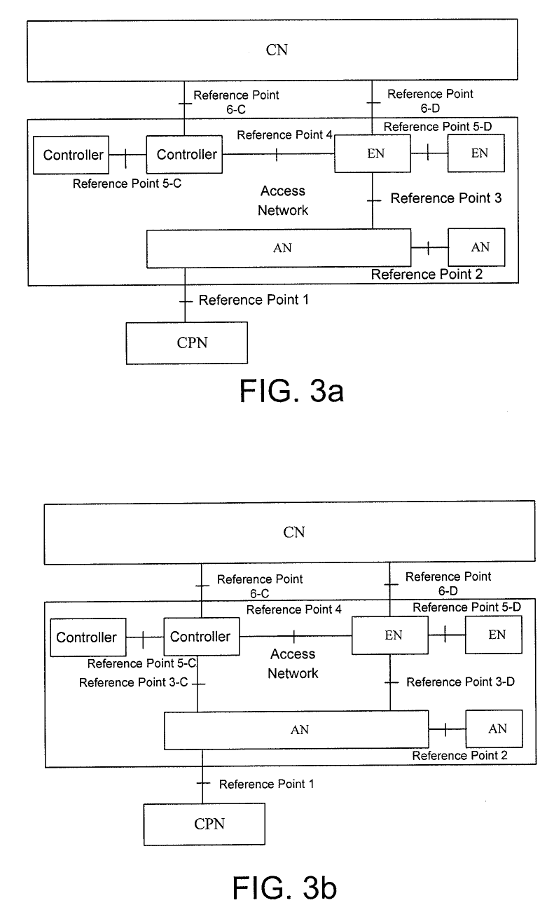

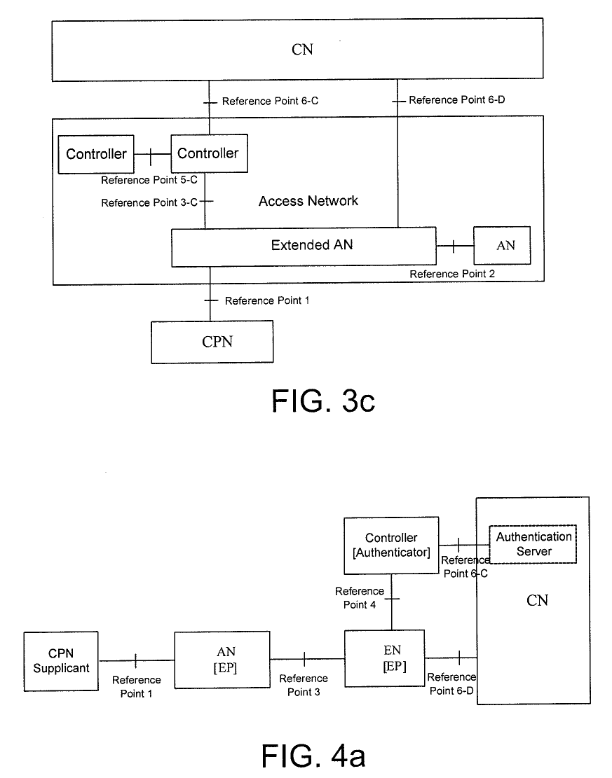

According to the network models of the two access networks with separated control and bearer as illustrated in FIG. 2a and FIG. 2b, the present invention provides architectures of three access networks as illustrated in FIG. 3a, FIG. 3b and FIG. 3c. In FIG. 3a-FIG. 3c, the ANs are wired ANs or wireless ANs, the ENs are wired ENs or wireless ENs, the controllers are wired controllers or wireless controllers or FMC controllers, and the CNs are wired CNs or wireless CNs or converged CNs including wired and wireless function; the access network control plane may support the fixed and mobile convergence in a form of separated control of a wired controller and a wireless controller, or support the fixed and mobile convergence in a form of collective control of an FMC controller. A reference point 1 between the CPN and an AN network element utilizes the reference point of the original access network; a reference point 2 is newly defined between the ANs for supporting communications between the ANs and adapting the requirements of communications based on Voice-over-Internet-Protocol (VoIP) technologies and Peer-to-Peer. Reference point 2 is optional, and a reference point between wired ANs is 2a, a reference point between wireless ANs is 2b, and a reference point between a wired AN and a wireless AN is 2c.

FIG. 3a is a first structure schematic diagram of an access network system of the present invention. As illustrated in FIG. 3a, the separation of control information and data is completed by an EN. The EN transfers the control information, such as a control message or signaling, through a reference point 4 to the controller for processing, and forwards the data flow through a reference point 6-D to the CN under control of the controller. The AN may be an access node supporting two layers.

A reference point 3 is newly defined between AN and EN, wherein the AN connects a user to the access network by a reference point 3. A reference point between a wired AN and a wired EN is 3a which utilizes a reference point of the original wired access network. A reference point between a wireless AN and a wireless EN is 3b which utilizes a reference point of the original wireless access network; a reference point between a wired AN and a wireless EN is 3c. A reference point between a wireless AN and a wired EN is 3d.

A reference point 4 is newly defined between the controller and EN, wherein the controller delivers strategy parameters to the EN through the reference point 4, and administrates the EN by the Media Gateway Control (Megaco) Protocol of IETF or H.248 of ITU-T. A reference point between a wired EN and a wired controller/FMC controller is 4a, and a reference point between a wireless EN and a wireless controller/FMC controller is 4b.

A reference point 5-C is newly defined between the controllers, and the controllers coordinate and uniform the resources and admission control as well as strategy control of the access network via the reference point 5-C. Reference point 5-C is optional. A reference point between a wired controller and a wired controller/FMC controller is 5a-C, a reference point between a wireless controller and a wireless controller/FMC controller is 5b-C, a reference point between a wired controller and a wireless controller is 5c-C, and a reference point between FMC controllers is 5d-C.

A reference point 5-D is newly defined between ENs, and the ENs achieve loading sharing of communication traffic among ENs via the reference point 5-D. Reference point 5-D is optional. A reference point between wired ENs is 5a-D, a reference point between wireless ENs is 5b-D, and a reference point between a wired EN and a wireless EN is 5c-D.

A reference point 6-C is newly defined between the controller and CN, and the reference point 6-C is equivalent to a reference point portion between the original access network and the core network. A reference point between a wired controller and a wired CN/converged CN is 6a-C, a reference point between a wireless controller and a wireless CN/converged CN is 6b-C, a reference point between a wired controller and a wireless CN is 6c-C, a reference point between a wireless controller and a wired CN is 6d-C, and a reference point between an FMC controller and CN is 6e-C.

A reference point 6-D is newly defined between the EN and CN, and the reference point 6-D is equivalent to a reference point portion between the original access network and the core network. A reference point between a wired EN and a wired CN/converged CN is 6a-D, a reference point between a wireless EN and a wireless CN/converged CN is 6b-D, a reference point between a wired EN and a wireless CN is 6c-D, and a reference point between a wireless EN and a wired CN is 6d-D.

FIG. 3b is a second structure schematic diagram of an access network system of the present invention. As illustrated in FIG. 3b, the separation of control information and data is completed by an AN. The AN transfers the control information, such as a control message or signaling, through a reference point 3-C to the controller for processing, and forwards the data flow through a reference point 3-D to CN under control of the controller. Reference points 2, 5-C, and 5-D are optional. The AN may be an access node supporting IP awareness.

The distinctions of the structure shown in FIG. 3b from that shown in FIG. 3a are as follows.

A reference point 3-C is newly defined between the AN and the controller, and the reference point 3-C is equivalent to a reference point portion between the AN and the access network edge node, such as a BNG/BRAS/ASN GW, of the original wired access network, and is configured for information exchanging between the AN and the controller. A reference point between a wired AN and a wired controller/FMC controller is 3a-C, and a reference point between a wireless AN and a wireless controller/FMC controller is 3b-C.

A reference point 3-D is newly defined between the AN and EN, and the reference point 3-D is equivalent to a reference point portion between the AN and the access network edge node, such as a BNG/BRAS/ASN GW, of the original wired access network, and is configured for information exchanging between the AN and EN. A reference point between a wired AN and a wired EN is 3a-D, a reference point between a wireless AN and a wireless EN is 3b-D, a reference point between a wired AN and a wireless EN is 3c-D, and a reference point between a wireless AN and a wired EN is 3d-D.

FIG. 3c is a third structure schematic diagram of an access network system of the present invention. As illustrated in FIG. 3c, function of EN is integrated in AN. The separation of control information and data is completed by the AN integrated with EN function. The AN integrated with EN function is referred to as an extended AN in the present invention. The extended AN transfers the control information through a reference point 3-C to the controller for processing, and forwards the data flow through a reference point 6-D to CN under control of the controller. Reference points 2 and 5-C are optional and the AN may be an access node supporting IP routing. Meanwhile, as illustrated in FIG. 3c, reference points 5-D, 4 and 3-D do not exist because the ENs are integrated in the extended AN. In addition, the EN function may be integrated in the core network. Then, the controller is connected to the AN via a reference point 3-C, and the controller and AN are connected to the core network via a reference point 6-C and a reference point 3-D, respectively.

It should be clarified that the different names for the reference points in FIG. 3a-FIG. 3c are not intended to limit the reference points, but to distinguish the different reference points only.

For users to communicate by the access network having separated control and bearer of the present invention, a method includes: separating control information from data when dealing with user uplink traffic at the access network data plane, transferring the separated control information to the access network control plane for processing, exchanging the control information with the core network, and forwarding the separated data and downlink data from the core network under control of the access network control plane.

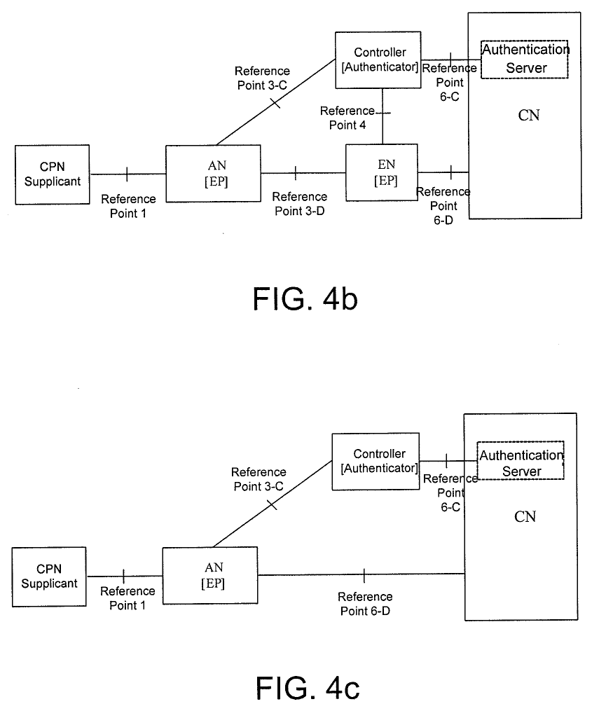

Take user authentication with the access network of the present invention as an example, the implementing process is described below in detail. FIG. 4a, FIG. 4b and FIG. 4c illustrate scenario examples of user authentication processes in a real network, respectively.

FIG. 4a is a first structure scenario of an access network implementing user authentication of the present invention. As shown in FIG. 4a, AN and EN may set Enforcement Points (EPs), thus the function, such as user's access control and strategy control, may be implemented within both the AN and EN. The EN also performs Relay/Proxy function: the Relay/Proxy needs to separate control information, e.g., a control message and signaling, from all flows and transfers the control information to the controller. For example, the EN separates an authentication message or a DHCP message from an authentication supplicant at a Customer Premise Network (CPN) and transfers the message to the controller. The authentication message or DHCP message sent from the controller to the user is also transferred by the EN. The separating method here belongs to prior art, such as separating by a protocol number or a port number of a flow classification detection message, and is not repeated herein.

FIG. 4b is a second structure scenario of an access network implementing user authentication of the present invention. As shown in FIG. 4b, there is a reference point 3-C between AN and the controller. The Relay/Proxy function in EN may be implemented in AN, i.e., the AN transfers the authentication message or DHCP message via reference point 3-C. EP may be implemented in the AN or EN.

FIG. 4c is a third structure scenario of an access network implementing user authentication of the present invention. As shown in FIG. 4c, AN performs the function of Relay/Proxy and EP, while the EN (not shown in FIG. 4c) neither involves in user authentication, nor supports EP.

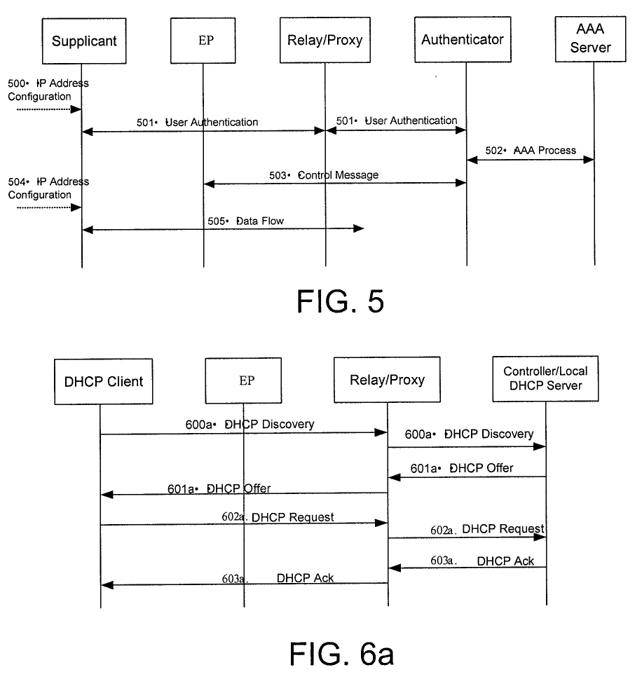

FIG. 5 is a flowchart of user authentication based on an access network system of the present invention. As shown in FIG. 5, a Supplicant is an applicant of user authentication; EP is an Enforcement Point for performing user access control, i.e., accessing the authenticated user and denying access of other users; an Authenticator is an authenticating party for authenticating and authorizing users, and for conforming user's authentication information and authorities by an authentication server (AS), such as an AAA server. The AS verifies the user's information and returns the authentication result back to the Authenticator, and may further return corresponding control information such as bandwidth and strategy for the authenticated user. The function of Relay/Proxy includes transferring authentication information between the Supplicant and the Authenticator. The authentication method of the present invention includes the following steps.

### Step 500: IP Address Configuration.

The user may configure the IP Address dynamically or statically, and this step is optional. Step 500 may be desired for certain authentication manners, such as the Protocol for carrying Authentication for Network Access (PANA).

### Step 501: User Authentication.

The Authenticator authenticates the Supplicant, and messages exchanging between thereof during the authentication process is detected and transferred by the Relay/Proxy. The Relay/Proxy detects the authentication message by separating control information such as a control message and signaling from the received flow. The detection method here belongs to prior art, such as detecting by a protocol number and a port number of a flow classification detect message.

At step 502, the Authenticator inquires the AAA server for user information, so as to authenticate and obtain a relevant strategy.

At step 503, the Authenticator delivers control information such as the access authority of the authenticated user to the EP. Meanwhile, the Authenticator may inquire and maintain the control information of the EP.

At step 504, if desired by the authenticated user, an IP address may be configured, typically a dynamic address configuration.

If not desired, this step may be omitted.

At step 505, a data flow from the authenticated user is forwarded across the EP.

Although the authentication method belongs to the prior art, what is emphasized here is the corporation between the access network control plane and access network data plane when authentication is implemented in the access network having separated control and bearer of the present invention.

During the user authentication in step 501 above, the authentication may be a process of a standard protocol, e.g., using PANA, 802.1X, etc., or may be a DHCP request. The detection for authentication message by the Relay/Proxy may be detection for an authentication protocol message, such as detection for a PANA message, an IEEE802.1X protocol message, or a Point-to-Point Protocol over Ethernet (PPPoE) message, may be detection for a broadcast message, such as detection for a DHCP request, or may be detection for a message with unknown source IP address or other message in a manner not illustrated in the present invention. For example, PANA is employed as an authentication mechanism in the scenario constituting an access network shown in FIG. 4a-FIG. 4c. The corresponding relationships between entities in the authentication process described in FIG. 5 and respective entities in PANA are as follows. The Supplicant corresponds to a PANA Client (PaC), the EP corresponds to EP, the Authenticator corresponds to a PANA Authentication Agent (PaA), and the AAA server corresponds to AS. For a further example, 802.1X is employed as an authentication mechanism in the scenario constituting an access network shown in FIG. 4a-FIG. 4c. The corresponding relationships between entities in the authentication process described in FIG. 5 and respective entities in 802.1X are as follows. The Supplicant corresponds to a Supplicant, EP corresponds to an Access Controller according to 802.1X, the Authenticator corresponds to an Authenticator, and the AAA server corresponds to AS.

In a real network, the Authenticator and the AAA Server may be in one physical entity, or may be provided in two different physical entities respectively; EP may be provided in either AN or EN; Relay/Proxy may be provided in one or more physical entities, and the physical entity in which the Relay/Proxy resides may also have EP being provided. EP and Relay/Proxy may be in the same physical entity or may be provided in different physical entities respectively.

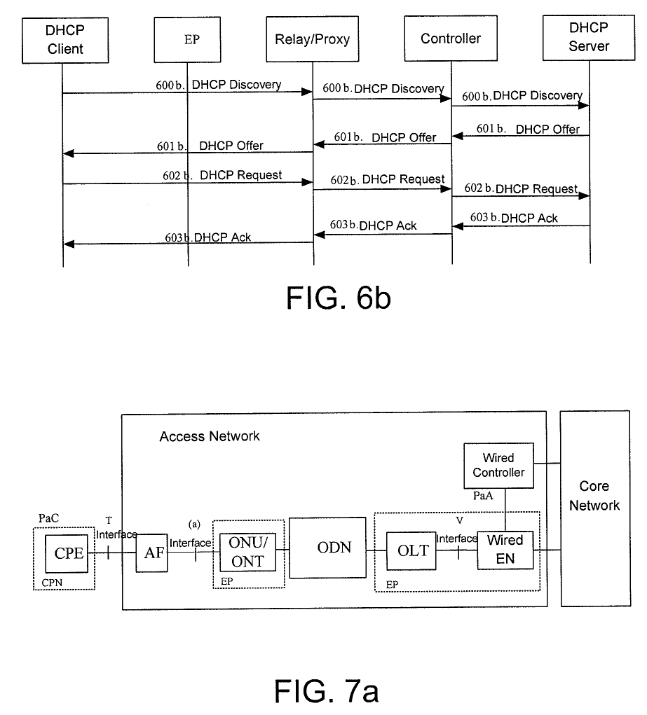

During the user authentication process as illustrated in FIG. 5, in step 500 or step 504, the user may configure an IP address statically or dynamically. In case of dynamic configuration, the configuration may be implemented by the process shown in FIG. 6a or FIG. 6b. FIG. 6a is a first flowchart of a DHCP process. Assuming that the controller includes a local DHCP server, as shown in FIG. 6a, an unauthenticated user without an IP address uses the local DHCP server to assign an address, and the Relay/Proxy transfers a DHCP message. The DHCP process between the user and the controller shown in FIG. 6a is a standard DHCP process, the detail description for which may be seen in the relevant specification and thus is not repeated here.

FIG. 6b is a second flowchart of a DHCP process. As shown in FIG. 6b, the distinction from FIG. 6a is that the controller and the DHCP server are entities separated from each other. The DHCP process between the user and the DHCP server is a standard DHCP process, the detail description for which may be seen in the relevant specification and thus is not repeated here.

The constitution of an access network with separated control and bearer and the method for a user to communicate by the access network of the present invention, have been introduced above. As can be seen from the access network of the present invention, because control and bearer are separated in the access network, the network control method does not need to change when the bearing technique changes, thereby improving the network extensibility while reducing the network maintenance cost.

The control portion is separated from the existing bearing device to be a stand-alone controller, thereby reducing the cost of the bearing device significantly. Meanwhile, the controller is not constrained by the hardware of the bearing device, so as to establish a solid basis for better performance. The separated controller may readily provide more and stronger control function by adding control function modules, and new services may also be supported conveniently by adding new modules into the controller, hence, the network extensibility is improved.

Moreover, the controller may be upgraded solely to improve performance without influencing the bearing network device; the upgrading and changing of the bearing network device do not influence user control, and the user administration control information does not need to alter due to the change of the bearing device, thus reducing the network maintenance cost significantly.

Besides, based on the separation of the access network control plane and the access network data plane of the present invention, control planes of different bearing technologies may be converged together, so as to provide a uniform control plane for different bearing technologies. The uniform management for services from a plurality of different service providers may be supported with the uniform control plane, enabling the access network system of the present invention to be applicable for scenarios of multiple SPs, and solving the problems such as cross-region handoff and roaming for users. The uniform control plane achieves the uniform management for different access technologies, thus solving the problems such as handoff between different access technologies and roaming for users.

The architecture of the present invention provides different stages of evolvement from the existing network architecture, including the different stages of AN supporting IP awareness, three layers, etc. As shown in FIG. 3, FIG. 3a adds a controller in the existing network architecture to separate the control function from EN; FIG. 3b further adds a reference point 3-C between the AN and the controller based on FIG. 3a, for the control message or signaling to be transferred to the controller via AN or EN. Both the AN and EN may implement EP; based on FIG. 3b, FIG. 3c removes the EN nodes, and the reference points between EN and the controller as well as between EN and AN, wherein the function of EN are integrated in AN, and wherein the reference point between the original EN and CN becomes a reference point between AN and CN. The architecture of the present invention is applicable for new services such as VoIP and Peer-to-Peer.

The applications of the present invention in Fiber-to-the-x (FTTx), such as FTTB, FTTC and FTTH, in digital subscriber loop (DSL) and in wireless network are described in conjunction with the real networks as examples.

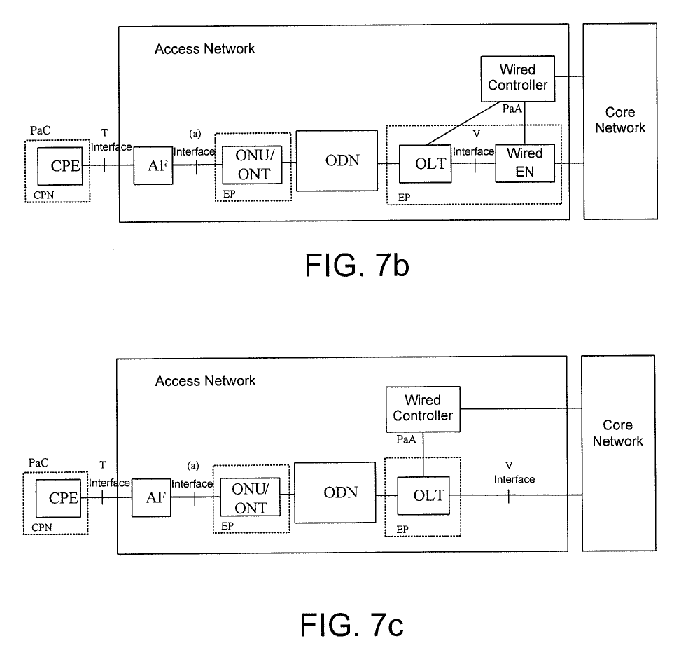

FIG. 7a is a first scenario of applying an access network of the present invention in FTTx. FIG. 7a is a network structure of applying FIG. 3a in FTTx. In connection with FIG. 3a, a wired controller is the controller, an Optical fiber Network Unit/Optical fiber Network Terminal (ONU/ONT) is the AN, and a wired EN is the EN. An Optical Line Terminal (OLT) does not belong to AN, and may be combined with the wired EN together into a same physical entity EP. A Customer Premise Equipment (CPE), an Optical Distribution Network (ODN) and Adaptation Function (AF) in FIG. 7a are existing entities, wherein the ODN provides an optical transmission medium for OLT and ONU as a physical connection between thereof, and the AF implements adaption function between optical access and other access technologies or services. In addition, the OLT and the wired EN may be provided in a same physical entity and collectively referred to as a wired EN. Then, the wired controller is the controller, the ONU/ONT is the AN, and the OLT establishes connection with the controller.

FIG. 7b is a second scenario of applying an access network of the present invention in FTTx. FIG. 7b is a network structure of applying FIG. 3b in FTTx. In connection with FIG. 3b, a wired controller is the controller, OLT is the AN, and a wired EN is the EN. In addition, the OLT and the wired EN may be provided in a same physical entity and collectively referred to as a wired EN. Then, the wired controller is the controller, the ONU/ONT is the AN, and the AN as well as the wired EN establish connections with the wired controller, respectively.

FIG. 7c is a third scenario of applying an access network of the present invention in FTTx. FIG. 7c is a network structure of applying FIG. 3c in FTTx. In connection with FIG. 3b, a wired controller is the controller, and ONU/ONT and OLT are configured as an AN/extended AN.

Interfaces T, (a) and V in FIG. 7a-FIG. 7c are interfaces in the prior art. Because a control plane and a bearing plane are not separated in the existing network, the existing interfaces above include reference points of the control plane and reference points of the bearing plane.

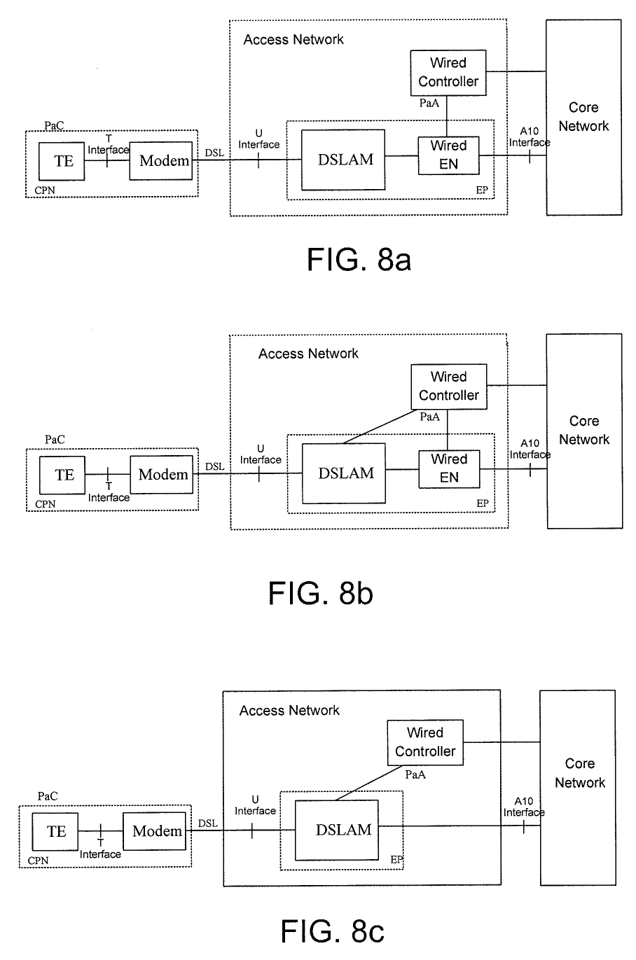

FIG. 8a is a first scenario of applying an access network of the present invention in DSL. FIG. 8a is a network structure of applying FIG. 3a in DSL. In connection with FIG. 3a, a wired controller is the controller, a Digital Subscriber Line Access Multiplexer (DSLAM) is the AN, and a wired EN is the EN.

FIG. 8b is a second scenario of applying an access network of the present invention in DSL. FIG. 8b is a network structure of applying FIG. 3b in FTTx. In connection with FIG. 3b, a wired controller is the controller, DSLAM is the AN, and a wired EN is the EN. Distinct from FIG. 8a, the wired controller is connected with the DSLAM.

FIG. 8c is a third scenario of applying an access network of the present invention in DSL. FIG. 8c is a network structure of applying FIG. 3c in FTTx. In connection with FIG. 3c, a wired controller is the controller, and DSLAM is the AN/extended AN.

Interfaces U, V, A10 in FIG. 8a-FIG. 8c are interfaces in the existing networks, and have the following corresponding relationships with the reference points in FIG. 3a. The interface U corresponds to reference point 1, the interface V corresponds to reference point 3, and the interface A10 corresponds to reference point 6. Because a control plane and a bearing plane are not separated in the existing network, the existing interfaces above include reference points of the control plane and reference points of the bearing plane.

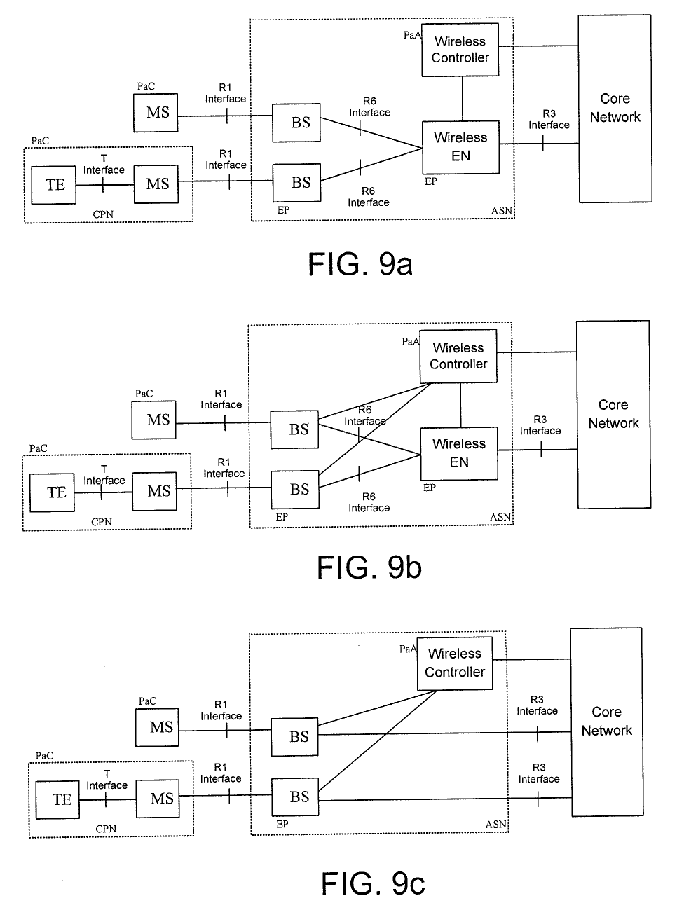

FIG. 9a is a first scenario of applying an access network of the present invention in a wireless network. FIG. 9a is a network structure of applying FIG. 3a in DSL. In connection with FIG. 3a, a wireless controller is the controller, a base station (BS) is the AN, and a wireless EN is the EN.

FIG. 9b is a second scenario of applying an access network of the present invention in a wireless network. FIG. 9b is a network structure of applying FIG. 3b in DSL. In connection with FIG. 3b, a wireless controller is the controller, BS is the AN, and a wireless EN is the EN. Distinct from FIG. 8a, the wireless controller is connected with the BS.

FIG. 9c is a third scenario of applying an access network of the present invention in a wireless network. FIG. 9c is a network structure of applying FIG. 3c in FTTx. In connection with FIG. 3c, a wireless controller is the controller, and BS is the AN/extended AN.

Interfaces R1, R3 and R6 in FIG. 9a-FIG. 9c are interfaces in the existing networks, and have the following corresponding relationships with the reference points in FIG. 3a: the interface R1 corresponds to reference point 1, the interface R6 corresponds to reference point 3, and the interface R3 corresponds to reference point 6. Because a control plane and a bearing plane are not separated in the existing network, the existing interfaces above include reference points of the control plane and reference points of the bearing plane.

The wired controllers in FIG. 7a-FIG. 7c and FIG. 8a-FIG. 8c, as well as the wireless controllers in FIG. 9a-FIG. 9c above may be implemented with FMC controllers.

The foregoing are exemplary embodiments of the present invention, rather than to limit the protection scope of the present invention. Any modification, equivalent and alternative, and improvement that fall within the spirit and principle of the present invention are intended to be embraced in the protection scope of the present invention.

What is claimed is:

1. An access network system with separated control and bearer, comprising an access network control plane and an access network data plane which are separated from each other, wherein
the access network control plane receives control information separated from the access network data plane, exchanges the control information with a core network, and controls data transfers of the access network data plane; and
the access network data plane separates control information from data carried in traffic between the core network and a user network, transfers the control information to the access network control plane, and forwards the data from one of the user network and the core network under the control of the access network control plane.

2. The system of claim 1, wherein the access network control plane is one of a wired access network control plane and a wireless access network control plane and the access network control plane is a converged access network control plane.

3. The system of claim 1, wherein the access network data plane is one of a wired access network data plane and a wireless access network data plane and the access network data plane is a converged access network data plane.

4. The system of claim 1, wherein
control functions of the access network control plane are provided in a controller that implements the control function of the access network,
functions of the access network data plane are provided in an edge node (EN),
the controller is connected to the EN by a first reference point,
the EN is connected to an existing access node (AN) by a second reference point, and
the controller and the EN are connected to the core network via a third reference point and a forth reference point respectively.

5. The system of claim 1, wherein
control functions of the access network control plane are provided in a controller which implements control function of the access network,
functions of the access network data plane are provided in an access node (AN),
the controller is connected to the AN via a first reference point,
the controller is connected to an edge node (EN) by a second reference point,
the AN is connected to the EN by a third reference point, and
the controller and the EN are connected to the core network via a forth reference point and a fifth reference point, respectively.

6. The system of claim 1, wherein
control functions of the access network control plane are provided in a controller which implements control functions of the access network,
functions of the access network data plane are provided in one of an access node (AN) and an extended AN having edge node (EN) functions,
the controller is connected to the extended AN by a first reference point
the controller and the extended AN are connected to the core network by a second reference point and a third reference point, respectively,
the controller is connected to the AN by a forth reference point, and
the controller and the AN are connected to the core network by a fifth reference point and a sixth reference point, respectively.

7. The system of claim 4, wherein the controller is one of a wired controller, a wireless controller, and a fixed and mobile converged (FMC) controller including functions of the wired controller and the wireless controller.

8. The system of claim 4, wherein the access network system is applicable to an optical fiber access network,
the controller is one of a wired controller and a fixed and mobile converged (FMC) controller,
the AN is one of an optical fiber network unit (ONU) and an optical fiber network terminal (ONT) in the optical fiber access network, and
the EN is a wired EN integrated with an Optical Line Terminal (OLT).

9. The system of claim 5, wherein the access network system is applicable to an optical fiber access network,
the controller is one of a wired controller and a fixed and mobile converged (FMC) controller,
the AN is an Optical Line Terminal (OLT) in the optical fiber access network, and
the EN is a wired EN.

10. The system of claim 6, wherein the access network system is applicable to an optical fiber access network,
the controller is one of a wired controller and a fixed and mobile converged (FMC) controller,
the controller is connected to an Optical Line Terminal (OLT), and
the AN and the extended AN are one of the ONU, the ONT, and the OLT.

11. The system of claim 4, wherein
the access network system is applicable to a digital subscriber loop,
the controller is one of a wired controller and a fixed and mobile converged (FMC) controller,
the AN is a Digital Subscriber Line Access Multiplexer (DSLAM) in the digital subscriber loop, and
the EN is a wired EN.

12. The system of claim 6, wherein the access network system is applicable to a digital subscriber loop,
the controller is one of a wired controller and a fixed and mobile converged (FMC) controller, and
the AN and the extended AN are DSLAMs.

13. The system of claim 4, wherein the access network system is applicable to a wireless network,
the controller is one of a wireless controller and a fixed and mobile converged (FMC) controller,
the AN is a base station in the wireless network, and
the EN is a wireless EN.

14. The system of claim 6, wherein the access network system is applicable to a wireless network,
the controller is one of a wireless controller and FMC controller, and
the AN and the extended AN are base stations (BSs).

15. The system of claim 4, wherein
each of the existing AN and the EN comprises an Enforcement Point (EP),
the controller is an authenticator,
the EN separates one of an authentication message and a Dynamic Host Configuration Protocol (DHCP) message from an authentication supplicant at a customer premise network (CPN), and transfers the message to the controller, and transfers one of the authentication message and the DHCP message sent from the controller to the supplicant,
the EN forwards data exchanged between the core network and the AN,
the AN is connected to the EN by the second reference point,
the EN is connected to the controller by the first reference point,
the EN is connected to the core network by the forth reference point, and
the controller is connected to an authentication server in the core network by a third reference point.

16. The system of claim 5, wherein
one of the AN and EN comprises an Enforcement Point (EP),
the controller is an authenticator,
the AN separates one of an authentication message and a Dynamic Host Configuration Protocol (DHCP) message from an authentication supplicant at a CPN, transfers the message to the controller, and transfers at least one of the authentication message and the DHCP message sent from the controller to a user,
the EN forwards data exchanged between the core network and the AN,
the AN is connected to the EN by the third reference point, the AN is connected to the controller by the first reference point 3-C, the EN is connected to the controller by the second reference point, the EN is connected to the core network by the fifth reference point, and the controller is connected to an authentication server in the core network by the forth reference point.

17. The system of claim 6, wherein
the AN comprises an Enforcement Point (EP),
the controller is an authenticator,
the AN separates at least one of an authentication message and a Dynamic Host Configuration Protocol (DHCP) message from an authentication supplicant at a CPN, transfers the message to the controller, and transfers the message sent from the controller to the supplicant,
the AN forwards data exchanged between the core network and a user,
the AN is connected to the controller by the first reference point, the AN is connected to the core network by the third reference point, and the controller is connected to an authentication server in the core network by the second reference point.

18. A method for achieving communication by an access network system having a control and a bearer separated from each other, comprising:
separating, by an access network data plane, control information from data carried in a user's uplink traffic, transferring the separated control information to an access network control plane for processing, and exchanging the control information with a core network; and
forwarding, by the access network data plane, the separated data and downlink data from the core network under a control of the access network control plane.

19. The method of claim 18, further comprising authenticating a user utilizing an authenticator prior separating the control information; and
separating and transferring, by the access network data plane, an authentication message exchanged between the user and the authenticator.

20. The method of claim 18, further comprising configuring an IP address by the user.

21. The system of claim 4, wherein
the access network system is applicable to an optical fiber access network,
the controller is one of a wired controller and an FMC controller,
the AN is an OLT in the optical fiber access network, and
the EN is a wired EN.

22. The system of claim 5, wherein
the access network system is applicable to an optical fiber access network,
the controller is one of a wired controller and a FMC controller,
the AN is one of the ONU and the ONT in the optical fiber access network, the EN is a wired EN, and
the OLT in the optical fiber access network is provided in the wired EN.
